(19) United States
(12) Patent Application Publication
(10) Pub. No.: US 2019/0336959 A1
(43) Pub. Date: Nov. 7, 2019

(54) PROCESS FOR TREATMENT OF SPENT IONIC LIQUIDS

(71) Applicant: RELIANCE INDUSTRIES LIMITED, Mumbai, Maharashtra (IN)

(72) Inventors: Vibhuti DUKHANDE, Pune, Maharashtra (IN); Visvanath KOTRA, Hyderabad, Telangana (IN); Parasuveera UPPARA, Navi Mumbai, Maharashtra (IN); Pavankumar ADURI, Dombivli, Maharashtra (IN); Suresh IYENGAR, Navi Mumbai, Maharashtra (IN); Prashant TANGADE, District Thane, Maharashtra (IN); Akhilesh YADAV, Thane (W), Maharashtra (IN)

(73) Assignee: Reliance Industries Limited, Mumbai, Maharashtra (IN)

(21) Appl. No.: 16/349,778

(22) PCT Filed: Dec. 6, 2017
(86) PCT No.: PCT/IB2017/057674

§ 371 Date: May 14, 2019

(30) Foreign Application Priority Data
Dec. 9, 2016 (IN) 201621042124

(51) Int. Cl. B01J 38/68; B01J 21/02; B01J 27/125; B01J 21/20; B01J 27/32; B01J 35/12

(52) U.S. Cl. CPC B01J 38/68; B01J 21/02; B01J 35/12; B01J 21/20; B01J 27/32; B01J 27/125

(57) ABSTRACT

The present disclosure provides a process for treatment a spent ionic liquid, comprising: mixing the spent ionic liquid with a first fluid medium and water to obtain slurry comprising a solid fraction and a liquid fraction; separating the solid fraction from slurry to obtain a filtrate and a residue comprising hydrated ionic solids; followed by drying the residue comprising the hydrated ionic solids at a temperature in the range of 60° C. to 120° C. to obtain treated ionic solids; and evaporating the filtrate to recover the fluid medium. The process of the present disclosure further comprises a step of contacting the treated ionic solids with at least one second fluid medium to separate an active ionic liquid.

### FIELD

The present disclosure relates to ionic liquids, specifically the present disclosure relates to treatment of spent ionic liquids.

### Definitions

As used in the present disclosure, the following terms are generally intended to have the meaning as set forth below, except to the extent that the context in which they are used indicates otherwise.

Spent/De-activated Ionic liquid: The term “Spent ionic liquid” or “De-activated ionic liquid” refers to ionic liquid that has been used in a process and is currently in a de-activated form or a partially de-activated form.

Clathrate: The term “clathrate” refers to a compound in which molecules of one component are physically trapped within the crystal structure of another.

Metallate: The term “metallate” refers to any complex anion containing a metal ligated to several atoms or small groups.

Eutectic: The term “eutectic” refers to a mixture of substances (in fixed proportions) that melts and freezes at a single temperature that is lower than the melting points of the separate constituents or of any other mixture of them.

### BACKGROUND

Ionic liquids have different applications in various fields. Ionic liquids are powerful solvents and electrically conducting fluids (electrolytes). Ionic liquids are inter alia used as catalysts in different reactions such as polymerization, oligomerization, alkylation, acylation and metathesis reactions. However, they are susceptible to contamination by other chemical compounds, such as unsaturated hydrocarbons, polymers, tar, etc.

Various attempts have been made for regeneration of de-activated ionic liquids or partially de-activated ionic liquids. However, the conventional processes provide only a partial recovery of the ionic liquids. Further, at some point of time, the residual spent ionic liquid has to be disposed. Since, ionic liquids are generally acidic in nature, the only available way is to treat them with a base in the presence of water, which results in a huge aqueous effluent and solid waste.

Therefore, there is felt a need to provide an effective process for treating spent ionic liquids that is simple economical and environment friendly. Further, there is a need of a process for treatment of spent ionic liquids that mitigates the drawbacks of the conventional methods mentioned hereinabove.

### OBJECTS

Some of the objects of the present disclosure, which at least one embodiment herein satisfies, are as follows.

It is an object of the present disclosure to ameliorate one or more problems of the prior art or to at least provide a useful alternative.

An object of the present disclosure is to provide a process for treatment of ionic liquid/eutectic mixture.

Another object of the present disclosure is to provide a process for treatment of a halo-metallate ionic liquid/eutectic mixture.

Yet another object of the present disclosure is to provide a process for separation of desired hydrocarbon after treating the spent ionic liquid.

Other objects and advantages of the present disclosure will be more apparent from the following description, which is not intended to limit the scope of the present disclosure.

### SUMMARY

The present disclosure relates to a process for treatment of spent ionic liquids. The process involves mixing the spent ionic liquid with a first fluid medium and water to obtain slurry comprising a solid fraction and a liquid fraction. The solid fraction is separated from slurry by filtration to obtain a filtrate and a residue comprising hydrated ionic solids. The residue comprising the hydrated ionic solids is dried at a temperature in the range of 60° C. to 120° C. to obtain treated ionic solids. The filtrate is evaporated to recover the first fluid medium.

In one embodiment, the spent ionic liquid is a halo-metallic based ionic liquid selected from the group consisting of chloroaluminate ionic liquid, imidazolium based chloroaluminate, phosphonium based chloroaluminate, pyridinium based chloroaluminate, N-methyl pyrrolidone based chloroaluminate, ammonium based chloroaluminate, substituted amine based chloroaluminate and combinations thereof.

In an embodiment, the chloroaluminate ionic liquid is a clathrate of benzene and Al(OH)₃:AlCl₃. The ratio of Al(OH)₃:AlCl₃ is in the range of 1:2 to 1:3.5, and the benzene in the mixture is in the range of 5 wt % to 50 wt %.

In another embodiment, the chloroaluminate ionic liquid is N-methyl pyrrolidone based chloroaluminate.

The first fluid medium is selected from the group consisting of primary aldehydes, secondary aldehydes, ketones, esters and combinations thereof.

The ratio of the first fluid medium to the spent ionic liquid is in the range of 1:1 to 10:1 by volume. The ratio of the first fluid medium to water is in the range of 20:1 to 5:1 by weight.

The process of the present disclosure further comprises a step of contacting the treated ionic solids with at least one second fluid medium to separate an active ionic liquid. The second fluid medium is at least one selected from the group consisting of water, dichloromethane, acetonitrile, alcohol, ketone, aldehyde, and ether.

### BRIEF DESCRIPTION OF THE ACCOMPANYING DRAWING

The present disclosure will now be described with the help of the accompanying drawing, in which:

FIG. 1 illustrates a flowchart depicting the process for treatment of the spent ionic liquid in accordance with the present disclosure.

### DETAILED DESCRIPTION

Ionic liquids are used inter alia as a catalyst and as a solvent in alkylation and polymerization reactions as well as in dimerization, oligomerization, acetylation, metathesis, and copolymerization reactions. As a result of repeated use, ionic liquid catalysts become deactivated or partially deactivated, i.e. lose activity, and may eventually need to be replaced and disposed of.

The present disclosure, therefore envisages a simple and economical process for treatment of spent ionic liquids. The process of the present disclosure comprises the following steps:

Initially, the spent ionic liquid is mixed with a first fluid medium and water to obtain slurry comprising a solid fraction and a liquid fraction. The solid fraction is separated from slurry by filtration to obtain a filtrate and a residue comprising hydrated ionic solids. The residue comprising the hydrated ionic solids is dried at a temperature in the range of 60° C. to 120° C. to obtain treated ionic solids. The filtrate obtained after step of filtration is evaporated to recover the first fluid medium.

In accordance with the present disclosure, the recovered first fluid medium can be recycled and reused without any further treatment.

In accordance with one embodiment of the present disclosure, the spent ionic liquid is a halo-metallic based ionic liquid selected from the group consisting of chloroaluminate ionic liquid, imidazolium based chloroaluminate, phosphonium based chloroaluminate, pyridinium based chloroaluminate, N-methyl pyrrolidone based chloroaluminate, ammonium based chloroaluminate, substituted amine based chloroaluminate and combinations thereof.

In accordance with the embodiments of the present disclosure, the ionic liquid can be in a clathrate form or in a non-clathrate form.

Typically, the ionic liquid is chloroaluminate ionic liquid, wherein the molar ratio of cation to AlCl₃ is in the range of 1:1 to 1:10.

In one exemplary embodiment, the chloroaluminate ionic liquid is a clathrate of benzene and Al(OH)₃:AlCl₃. The ratio of Al(OH)₃:AlCl₃ is in the range of 1:2 to 1:3.5, and the benzene in the mixture is in the range of 5 wt % to 50 wt %.

In another exemplary embodiment, the chloroaluminate ionic liquid is N-methyl pyrrolidone based chloroaluminate.

In accordance with the embodiments of the present disclosure, the first fluid medium is at least one selected from the group consisting of primary aldehydes, secondary aldehydes, ketones, esters and combinations thereof.

In accordance with the embodiments of the present disclosure, the ratio of the first fluid medium to the spent ionic liquid is in the range of 1:1 to 10:1 by volume.

In accordance with the embodiments of the present disclosure, the ratio of the first fluid medium to water is in the range of 20:1 to 5:1 by weight.

In accordance the present disclosure, the process wherein imidazolium or phosphonium or pyridinium based chloroaluminate based spent ionic liquids are to be treated, the process further comprises a step of extracting the treated ionic solids with at least one second fluid medium.

In case of imidazolium or phosphonium or pyridinium based chloroaluminate ionic liquids, the active ionic liquid also precipitates along with the hydrated ionic solids, which needs to be recovered.

The treated ionic solids comprising an active ionic liquid is further contacted with a second fluid to obtain a slurry comprising a solid fraction and a liquid fraction. The solid fraction is separated by filtration to obtain a residue comprising the ionic solids and a filtrate comprising an active ionic liquid. The residue is dried to obtain ionic solids. The filtrate is evaporated to obtain a recovered ionic liquid. The second fluid medium can be recovered and recycled without any further treatment.

In accordance with the present disclosure, the second fluid medium is at least one selected from the group consisting of water, dichloromethane, acetonitrile, methyl tert butyl ketone, primary alcohol, secondary alcohol, ketone, aldehyde, and ether.

In an exemplary embodiment of the present disclosure, the spent ionic liquid is chloroaluminate based spent ionic liquid. The present disclosure utilizes a polar solvents as first fluid medium, which completely solubilizes the chloroaluminate based spent ionic liquid along with the contaminants present in it such as tar and other polymers. The addition of the stoichiometric quantity of water results in formation of hydrated aluminium ions and chloride ions:

AlCl₃(s)+aq→[Al(H₂O)₆]³⁺(aq)+3Cl⁻(aq)

The small, highly charged metal ion polarizes (withdraws electron density from) the water molecules that are attached through dative covalent bonds. This makes the hydrogen atoms d+ and susceptible to attack from water, which is acting as a base.

[Al(H₂O)₆]³⁺(aq)+H₂O(l)→[Al(H₂O)₅OH]²⁺(aq)+H₃O⁺(aq)

The moment chloroaluminate based spent ionic liquid is added to the first fluid medium and water, the spent ionic liquid will disassociate and will give hydrated AlCl₃, (Al(H₂O)₆Cl₃), which is an ionic solid, containing the (Al(H₂O)₆)³⁺ cation. Since, the mixture of the first fluid medium and water is highly polarized, tar along with other polymers remain in the soluble form in the mixture.

In accordance with one embodiment of the present disclosure, the desired polymers can be recovered from the filtrate comprising first fluid medium and other contaminants such as polymers and tar.

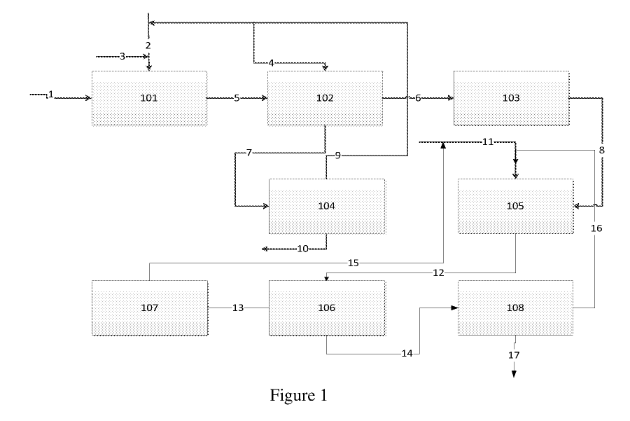

The process of the present disclosure is further illustrated with the help of accompanying drawing (FIG. 1).

FIG. 1 illustrates a flowchart depicting the process for treatment of spent ionic liquid. The process can be operational in either batch or semi-continuous or continuous mode.

(101) represents pre-mixer; the pre-mixer can be either a stirred vessel or static mixer or jet mixer or pump mixer;

(102, 106) represent filter; the filter can be selected from the group consisting of centrifuge filter, pressure nutsche filter, agitated nutsche filter, vacuum filter, belt filter and combinations thereof. In another embodiment a filter-dryer combination, such as agitated nutsche filter dryer, (103, 107) can be used. The filter-dryer combination can be one of single effect, multiple effect dryer, tray-dryer, agitated thin film dryer, paddle dryer, and combinations thereof.

(104) represents distillation column; the distillation column can be selected from the group consisting of single stage tray column, multi stage tray column, packed column, falling film evaporator, agitated thin film evaporator, and combinations thereof.

(105) represents extractor; the extractor can be selected from the group consisting of single stage, multistage, co-current, counter current, stirred vessel, and extraction column.

(108) represents solvent evaporator or dryer, the evaporator can be selected from the group consisting of single effect evaporator, multiple effect evaporator, agitated thin film evaporator, and combinations thereof.

Stream 1 containing a spent halo-metallic ionic liquid is directly send to mixer (101) where it is mixed with a first fluid medium and water in stream 2 and 3, respectively. Alternately there can be another pre-mixer for separately mixing the stream 1 and 2, followed by mixing with stream 3 in mixer (101). The residence time inside the mixer is in the range of 5 minutes to 60 minutes for complete precipitation of hydrated ionic solids.

The slurry formed in reactor (101) is sent into filter (102) via stream 5. The solids comprising the hydrated ionic solids is washed with excess first fluid medium (via stream 4) to remove the traces of tar and other polymer contaminants, if any.

The solids retained on the filter (102) are sent to evaporator or dryer (103) through stream 6 where the solids are dried. The drying is typically carried out in the temperature range of 60° C. to 120° C. The drying can be carried out at atmospheric pressure or under vacuum or combination of both. Stream 8 obtained after drying is the treated ionic solids.

The filtrate obtained from (102) is sent through stream 7 to distillation column (104) to distill out first fluid medium, which is recycled as such via stream 9, leaving behind tar and other polymers as residue (stream 10).

In case of imidazolium or phosphonium or pyridinium based chloroaluminates, an active ionic liquid also precipitates out along with the hydrated ionic solids, which needs to be recovered.

The treated ionic solids obtained from the drier (103) via stream 8 is sent to extractor (105), where it is contacted with a second fluid medium coming from stream 11 in order to separate an active ionic liquid from the treated ionic solids. The extractor outlet is sent through stream 12 to filter (106) where solids containing the hydrated ionic solids are separated and sent to dryer (107) via stream 13. The mother liquor comprising an active ionic liquid from filter (106) is sent to evaporator (108) via stream 14 to separate the second fluid medium via stream 16 and a solids via steam 17 which is a recovered active ionic liquid.

The evaporated solvent from dryer (107) and also from evaporator (108) is recycled back to extractor (105) via stream 15 and 16, respectively.

The present disclosure provides a simple and economical process for treatment of spent ionic liquid. The process of the present disclosure does not produce any aqueous effluents or solid wastes and therefore the process is environmental friendly. Further, the process of the present disclosure enables the recovery of the polymers in the spent ionic liquid.

The present disclosure is further described in light of the following experiments which are set forth for illustration purpose only and are not to be construed for limiting the scope of the disclosure. The following experiments can be scaled up to industrial/commercial scale and the results obtained can be extrapolated to industrial scale.

### EXPERIMENTAL DETAILS

### Example-1: To Obtain a Spent Ionic Liquid Catalyst

### Experiment-1: Alkylation Reaction to Obtain the Spent Ionic Liquid Catalyst

250 liters per hour (LPH) of benzene was mixed with 3.6 LPH of fresh catalyst consisting of clathrate of chloroaluminate (contains 50% benzene by weight and Al(OH)₃:AlCl₃ in 1:3 mole ratio) in a static mixer, this stream was passed through another static mixer where it was mixed with 500 LPH of hydrocarbon stream containing 12% C₁₀-C₁₄ olefins and 88% paraffins. All the streams were maintained at 47° C. The outlet stream was then passed through a settler having a residence time of 20 minutes. The upper hydrocarbon layer was further processed while the bottom spent catalyst layer was collected separately in a container for regeneration. The conversion of olefin was found to be 99.7%. The bottom spent catalyst layer was kept aside in a closed container.

### Experiment-2: Trans-Alkylation of Spent Ionic Liquid Catalyst

750 ml of heavier alkyl benzene was mixed with 750 ml of benzene in a 2 liter RB flask equipped with an over-head stirrer. At 80° C., 255 g of spent catalyst layer obtained from Experiment-1 was charged and stirred for 2 hours. After 2 hours, the mixture was cooled to 45° C. and the layers were separated. The bottom catalyst layer was used for further treatment.

### Example 2: Treatment of the Spent Ionic Liquids

### Experiment-3: Treatment of the Spent Ionic Liquid Using Acetone and Water

100 g of spent ionic liquid obtained from Experiment-1 was mixed with 440 g of acetone-water mixture (10.9 wt % of water) to obtain slurry comprising a solid fraction and a liquid fraction. The slurry was filtered to obtain a residue comprising hydrated ionic solids and a filtrate comprising tar and other hydrocarbons.

The so obtained residue was then dried under nitrogen to obtain treated ionic solids containing hexahydrate AlCl₃ along with Al(OH)₃. The filtrate was distilled off to recover acetone leaving behind the tar and hydrocarbons. The recovered acetone was recycled as such.

### Experiment-4: Treatment of the Spent Ionic Liquid Using Methyl Acetate and Water

100 g of spent ionic liquid obtained from Experiment-1 was mixed with 465 g of methyl acetate-water mixture (10.3 wt % of water) to obtain slurry comprising a solid fraction and a liquid fraction. The slurry was filtered to obtain residue comprising hydrated ionic solids and a filtrate comprising tar and other hydrocarbons.

The so obtained residue was then dried under nitrogen to obtain treated ionic solids containing hexahydrate AlCl₃ along with Al(OH)₃. The filtrate was distilled off to recover methyl acetate leaving behind the tar and hydrocarbons. The recovered methyl acetate was recycled as such.

### Experiment-5: Treatment of the Spent Ionic Liquid Using Acetone and Water System

100 g of spent ionic liquid obtained from Experiment-2 was mixed with 440 g of acetone-water mixture (10.9 wt % of water) to obtain slurry comprising a solid fraction and a liquid fraction. The slurry was filtered to obtain a residue comprising hydrated ionic solids and a filtrate comprising tar and other hydrocarbons.

The so obtained residue was then dried under nitrogen to obtain treated ionic solids containing hexahydrate AlCl₃ along with Al(OH)₃. The filtrate was distilled off to recover acetone leaving behind the tar and hydrocarbons. The recovered acetone was recycled as such.

### Experiment-6: Treatment of the NMP Based Spent Ionic Liquid Using Acetone and Water

The three neck flask was charged with 10 g NMP based spent ionic liquid and cooled to the temperature the range of 5° C. to 10° C. 100 g of acetone water mixture (10% water) was then added in drop-wise manner. White precipitate started forming. The resultant mixture was stirred for 2 hrs to obtain slurry comprising a solid fraction and a liquid fraction. After completion of the reaction, slurry was filtered to obtain a residue comprising hydrated ionic solids and a filtrate comprising tar and other hydrocarbons.

The so obtained residue was dried under nitrogen at 110° C. to obtain treated ionic solids which was stored at cool dry place. The filtrate was distilled off to recover acetone leaving behind the tar and hydrocarbons. The recovered acetone was recycled as such.

From the examples provided herein above, it is evident that the treatment of the spent ionic liquid as disclosed in the present disclosure is simple and economical. The process of the present disclosure can be applied for the treatment of the spent ionic liquid using a fluid medium and water without generating an aqueous effluent. Further, the contaminations present in the ionic liquid, such as tar and hydrocarbon can be recovered as a by-product. Still further, metals such as gallium (GA) and Indium (In) can be recovered from the mixture of the spent ionic liquid.

### Technical Advances and Economical Significance

The present disclosure described herein above has several technical advantages including, but not limited to, the realization of a process for treatment of the spent ionic liquids that:
avoids the generation of an aqueous effluent;
recovers the impurities present in the spent ionic liquids; and
is simple and economical.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

The use of the expression “at least” or “at least one” suggests the use of one or more elements or ingredients or quantities, as the use may be in the embodiment of the invention to achieve one or more of the desired objects or results. While certain embodiments of the inventions have been described, these embodiments have been presented by way of example only, and are not intended to limit the scope of the inventions. Variations or modifications to the formulation of this invention, within the scope of the invention, may occur to those skilled in the art upon reviewing the disclosure herein. Such variations or modifications are well within the spirit of this invention.

The numerical values given for various physical parameters, dimensions and quantities are only approximate values and it is envisaged that the values higher than the numerical value assigned to the physical parameters, dimensions and quantities fall within the scope of the invention unless there is a statement in the specification to the contrary.

While considerable emphasis has been placed herein on the specific features of the preferred embodiment, it will be appreciated that many additional features can be added and that many changes can be made in the preferred embodiment without departing from the principles of the disclosure. These and other changes in the preferred embodiment of the disclosure will be apparent to those skilled in the art from the disclosure herein, whereby it is to be distinctly understood that the foregoing descriptive matter is to be interpreted merely as illustrative of the disclosure and not as a limitation.

1. A process for treatment a spent ionic liquids, said process comprising the following steps:
a. mixing said spent ionic liquid with a first fluid medium and water to obtain slurry comprising a solid fraction and a liquid fraction;
b. separating said solid fraction from said slurry by filtration to obtain a filtrate and a residue comprising hydrated ionic solids;
c. drying said residue comprising said hydrated ionic solids at a temperature in the range of 60° C. to 120° C. to obtain treated ionic solids; and
d. evaporating said filtrate to recover said first fluid medium.

2. The process as claimed in claim 1, wherein said spent ionic liquid is halo-metallic based ionic liquid.

3. The process as claimed in claim 1, wherein said spent ionic liquid is at least one selected from the group consisting of chloroaluminate ionic liquid, imidazolium based chloroaluminate, phosphonium based chloroaluminate, pyridinium based chloroaluminate, N-methyl pyrrolidone based chloroaluminate, ammonium based chloroaluminate, substituted amine based chloroaluminate and combinations thereof.

4. The process as claimed in claim 3, wherein said chloroaluminate ionic liquid is N-methyl pyrrolidone based chloroaluminate.

5. The process as claimed in claim 3, wherein said chloroaluminate ionic liquid is a clathrate of benzene and Al(OH)₃:AlCl₃;
wherein the molar ratio of Al(OH)₃:AlCl₃ is in the range of 1:2 to 1:3.5, and the amount of benzene is in the range of 5 wt % to 50 wt %.

6. The process as claimed in claim 1, wherein said first fluid medium is at least one selected from the group consisting of primary aldehydes, secondary aldehydes, ketones, esters and combinations thereof.

7. The process as claimed in claim 1, wherein the ratio of said first fluid medium to said spent ionic liquid is in the range of 1:1 to 10:1 by volume.

8. The process as claimed in claim 1, wherein the ratio of said first fluid medium to water is in the range of 20:1 to 5:1 by weight.

9. The process as claimed in claim 1, wherein said step (c) further comprises a step of contacting said treated ionic solids with at least one second fluid medium to separate an active ionic liquid.

10. The process as claimed in claim 9, wherein said second fluid medium is at least one selected from the group consisting of water, dichloromethane, acetonitrile, alcohol, ketone, aldehyde, and ether.
